(19) United States
(12) Patent Application Publication
(10) Pub. No.: US 2012/0299877 A1
(43) Pub. Date: Nov. 29, 2012

(54) Optical Touch Display Device

(75) Inventors: Shao-Keng Huang, Zhongli City (TW); Shin-Chang Chen, Kinmen County (TW); Chi-Sheng Lin, Zhongli City (TW)

(73) Assignee: CHUNGHWA PICTURE TUBES, LTD., Bade City (TW)

(21) Appl. No.: 13/296,385

(22) Filed: Nov. 15, 2011

(30) Foreign Application Priority Data
May 27, 2011 (TW) 100209639

(51) Int. Cl. G06F 3/042

(52) U.S. Cl. 345/175

(57) ABSTRACT

An optical touch display device is provided. The optical touch display device includes a front frame, a light guide strip, a photosensitive element, and a light source. The front frame includes a body portion having a display opening, at least one positioning board located on a corner of the body portion, and a protecting cover located on the body portion. An end of the protecting cover is adjacent to the positioning board. An opening groove is defined between the protecting cover and the body portion. The body portion, the positioning board, and the protecting cover are integrally formed. The light guide strip is placed in the opening groove. The photosensitive element is fixed on the positioning board. The light source is located between the photosensitive element and the light guide strip, and a light-emitting side of the light source faces a light inlet side of the light guide strip.

### RELATED APPLICATIONS

This application claims priority to Taiwan Application Serial Number 100209639, filed May 27, 2011, which is herein incorporated by reference.

### BACKGROUND

1. Technical Field

The present disclosure relates to a touch display device, and more particularly to an optical touch display device.

2. Description of Related Art

There are several different types of touch panels, such as resistive touch panels, capacitive touch panels, optics touch panels, electromagnetic touch panels, and surface acoustic wave touch panels (i.e., Tangible Acoustic Interfaces). Because resistive touch panels were developed earlier than the other types of touch panels, the market share of resistive touch panels is greater than it is for the other touch panel types. However, optical touch panel display devices have advantages of high accuracy, high resolution, and quick response, and are not affected by the manufacturing processes of the display panels thereof. Therefore, optical touch panel display devices are suitable for display devices having large display regions.

An optical touch panel usually includes two complementary metal oxide semiconductor (CMOS) cameras or two charge coupled device (CCD) cameras located respectively on two ends of an upper edge of a display panel thereof. The optical touch panel display device utilizes the principles of receiving and interrupting light from infrared light emitting diodes (IR-LEDs), and utilizes retro-reflectors or light guide strips placed on edges of the display panel, such that the cameras located on corners of the display panel can detect the changes of the light rays. For example, when an external object (e.g., a touch pen or a finger) touches the display panel, a portion of the paths of the light rays are blocked, such that the cameras cannot receive the light rays blocked by the external object. At this time, the cameras detect some shadows and utilize a micro-controller unit (MCU) to compute the coordinates of the shadows.

However, because the optical touch panel display device includes the cameras and the light guide strips, additional frames need to be placed between a front frame and the display panel, such that the entire thickness of the optical touch panel display device is increased. A practical defeat is when the size of the display device including the optical touch panel small, the product competitiveness of the optical touch panel display device is degraded because of its large thickness.

FIG. 1A is a perspective view of a conventional optical touch display device 100. FIG. 1B is an exploded view of the conventional optical touch display device 100 shown in FIG. 1A. As shown in FIG. 1A and FIG. 1B, the conventional optical touch display device 100 includes a front frame 110, an optical touch module frame 120, a panel front fixing frame 130, a display panel 140, a panel back fixing frame 150, a bottom plate 160, and a back frame 170. The optical touch module frame 120 includes a photosensitive element 122. The display panel 140 is located in the front frame 110. Moreover, the display panel 140 includes a display region 144 and a panel frame 142 surrounding the display region 144.

FIG. 1C is a cross-sectional view taken along line 1C-1C of FIG. 1A. A distance D1 between the front frame 110 and the back frame 170 is defined by the thickness of the front frame 110, the optical touch module frame 120, the panel front fixing frame 130, the panel frame 142, the panel back fixing frame 150, the bottom plate 160, and the back frame 170. However, the thickness of each frame or plate mentioned above is difficult to decrease because the thickness is also related to elements placed on the frames or plates. Therefore, it is not easy to directly decrease the thickness of the frames without changing the elements located on the frames or the plates.

### SUMMARY

An aspect of the present invention is to provide an optical touch display device.

In an embodiment of the present invention, an optical touch display device includes a front frame, a light guide strip, a photosensitive element, and a light source. The front frame includes a body portion having a display opening, at least one positioning board located on a corner of the body portion, and a protecting cover located on the body portion. An end of the protecting cover is adjacent to the positioning board. An opening groove is defined between the protecting cover and the body portion. The body portion, the positioning board, and the protecting cover are integrated. The light guide strip is placed in the opening groove. The photosensitive element is fixed on the positioning board. The light source is located between the photosensitive element and the light guide strip, and a light-emitting side of the light source faces a light inlet side of the light guide strip.

Another aspect of the present invention is to provide an optical touch display device.

In an embodiment of the present invention, an optical touch display device includes a front frame, a display panel, a light guide strip, a photosensitive element, and a light source. The front frame includes a display opening. The display panel includes a display region and a panel frame surrounding the display region. The display panel is located in the front frame. The panel frame includes a body portion, at least one positioning board, and a protecting cover. The positioning board is located on a surface of the body portion facing the display opening and is placed on a corner of the body portion. The protecting cover located on the body portion. An end of the protecting cover is adjacent to the positioning board. An opening groove is defined between the protecting cover and the body portion. The body portion, the positioning board, and the protecting cover are integrated. The light guide strip is placed in the opening groove. The photosensitive element is fixed on the positioning board. The light source is located between the photosensitive element and the light guide strip, and a light-emitting side of the light source faces a light inlet side of the light guide strip.

In the aforementioned embodiment of the present invention, the body portion of the front frame or the panel frame of the optical touch display device includes the positioning board and the protecting cover, so that the photosensitive element, the light guide strip, and the light source may be placed on the body portion of the front frame or the panel frame. Therefore, compared with a conventional optical touch display device, it is not necessary to use additional frames, and the optical touch display device including the front frame or the panel frame accommodates the photosensitive element, the light guide strip, and the light source. Hence, the optical touch display device has a reduced thickness.

### BRIEF DESCRIPTION OF THE DRAWINGS

FIG. 1A is a perspective view of a conventional optical touch display device;

FIG. 1B is an exploded view of the conventional optical touch display device shown in FIG. 1A;

FIG. 1C is a cross-sectional view taken along line 1C-1C shown in FIG. 1A;

FIG. 2 is a partial perspective view of a front frame of an optical touch display device of an embodiment of the present invention;

FIG. 3A is a cross-sectional view taken along line 3A-3A shown in FIG. 2;

FIG. 3B is a front view of the photosensitive element shown in FIG. 2;

FIG. 4 is a partial perspective view of a front frame of an optical touch display device of another embodiment of the present invention;

FIG. 5A is a perspective view of an optical touch display device using the front frame shown in FIG. 2;

FIG. 5B is an exploded view of the optical touch display device shown in FIG. 5A;

FIG. 5C is a cross-sectional view taken along line 5C-5C shown in FIG. 5A;

FIG. 6A is a partial perspective view of a front frame of an optical touch display device of another embodiment of the present invention;

FIG. 6B is a partial perspective view of a combination of a display panel and the front frame shown in FIG. 6A;

FIG. 7A is a perspective view of an optical touch display device using the front frame shown in FIG. 6A;

FIG. 7B is an exploded view of the optical touch display device shown in FIG. 7A;

FIG. 7C is a cross-sectional view taken along line 7C-7C shown in FIG. 7A; and

FIG. 8 is a partial perspective view of a display panel of an optical touch display device of another embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

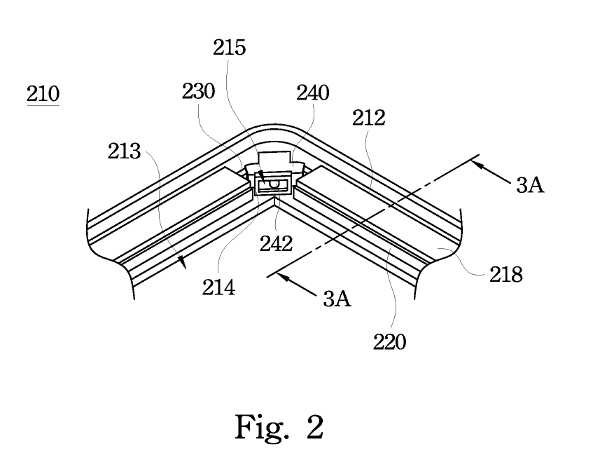

FIG. 2 is a partial perspective view of a front frame 210 of an optical touch display device of an embodiment of the present invention. The front frame 210 includes a body portion 212, at least one positioning board 214, and protecting cover 218. The body portion 212 includes a display opening 213. The positioning board 214 is located on a corner of the body portion 212. The protecting cover 218 is located on the body portion 212, and an end of the protecting cover 218 is adjacent to the positioning board 214. Moreover, a photosensitive element 240 is fixed on the positioning board 214. A light source 230 is located between the photosensitive element 240 and a light guide strip 220, and a light-emitting side of the light source 230 faces a light inlet side of the light guide strip 220.

The photosensitive element 240 includes a lens 242 facing the display opening 213. The positioning board 214 is located adjacent to a side of the photosensitive element 240 facing away from the lens 242 (i.e., the front side of the photosensitive element 240). The positioning board 214 further includes a transmissive region 215 corresponding to the lens 242. The positioning board 214 stands on the body portion 212 and supports the photosensitive element 240.

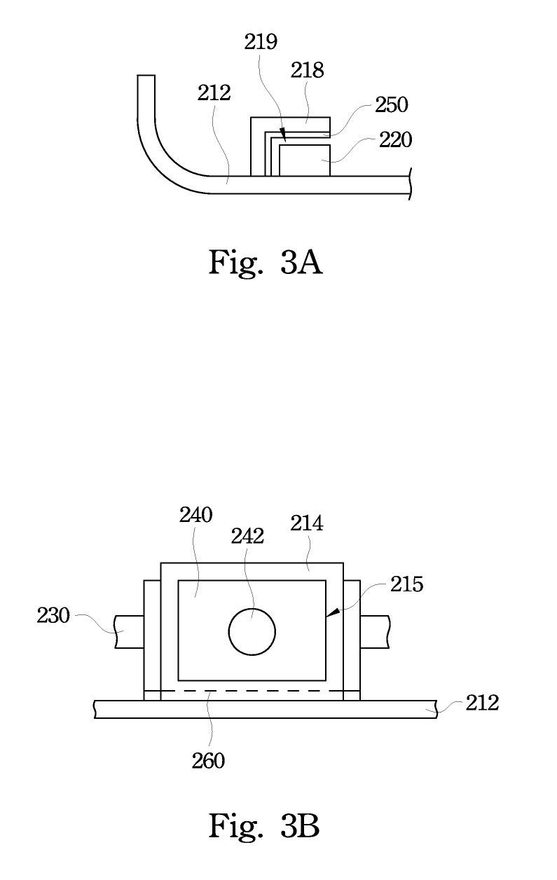

FIG. 3A is a cross-sectional view taken along line 3A-3A shown in FIG. 2. An opening groove 219 is defined between the protecting cover 218 and the body portion 212. The light guide strip 220 is placed in the opening groove 219. Furthermore, a reflective sheet 250 is adhered to an inner wall of the protecting cover 218 facing the light guide strip 220 to reflect light rays emitted from the light guide strip 220.

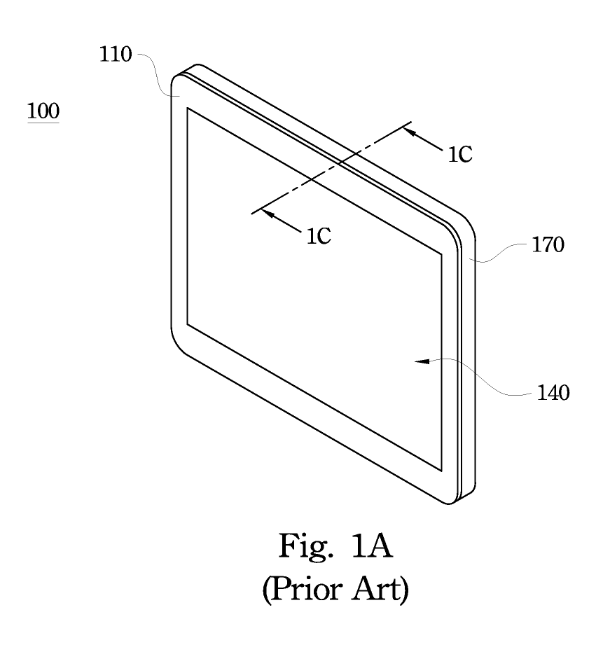

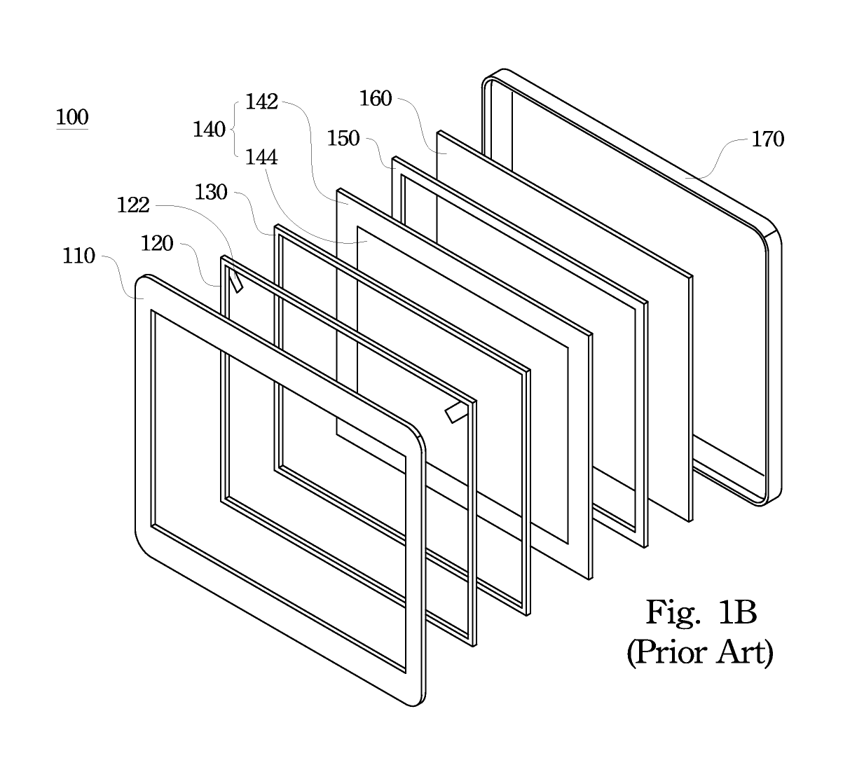

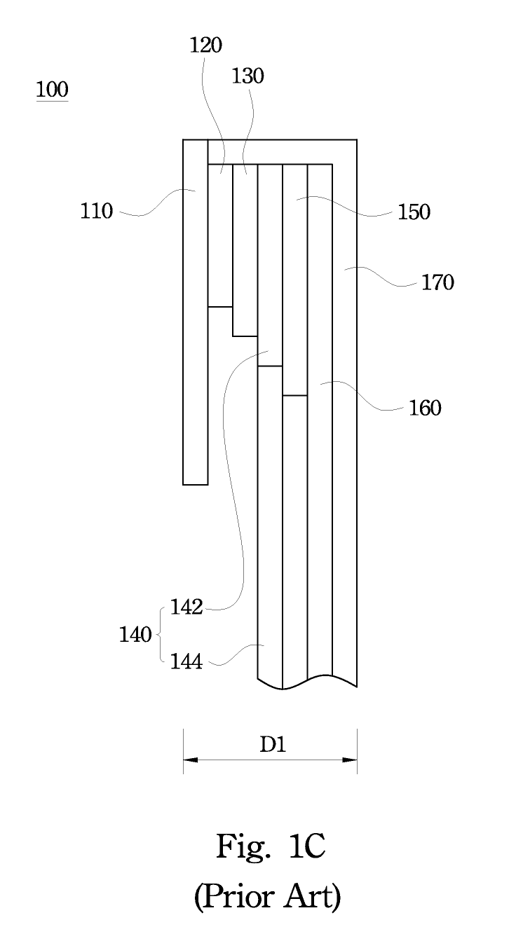

In this embodiment, the positioning board 214 includes the transmissive region 215 corresponding to the lens 242, such that the lens 242 may detect external light changes by the transmissive region 215. In some embodiments, one photosensitive element 240 is located in each corner on two ends of an upper long edge of the body portion 212 to detect light changes. In addition, the reflective sheet 250 located on the inner wall of the protecting cover 218 and the light guide strip 220 placed in the opening groove 219 can reflect light rays onto the photosensitive element 240. That is to say, when an external object (e.g., a touch pen or a finger) touches the display panel 140 (shown in FIG. 1A), a portion of paths of the light rays are blocked, such that the photosensitive element 240 cannot receive the light rays blocked by the external object. At this time, the photosensitive element 240 detects some shadows and utilizes a micro-controller unit (not shown) to compute the coordinates of the shadows.

FIG. 3B is a front view of the photosensitive element 240 shown in FIG. 2. In order to ensure that the photosensitive element 240 is firmly fixed adjacent to the positioning board 214, an adhesive layer 260 may be placed between the photosensitive element 240 and the body portion 212, such that the photosensitive element 240 is adhered on the body portion 212 by the adhesive layer 260.

In this embodiment, the body portion 212, the positioning board 214, and the protecting cover 218 may be integrated. The protecting cover 218 may have an L-shaped profile. The light source 230 may be light emitting diodes (LEDs). The adhesive layer 260 may be a double-sided adhesive. The photosensitive element 240 may be a complementary metal oxide semiconductor (CMOS) camera or a charge coupled device (CCD) camera.

The numbers and the positions of the positioning board 214, the protecting cover 218, and the adhesive layer 260 may be changed in accordance with practical requirements. For example, the adhesive layer 260 may be located between the photosensitive element 240 and the body portion 212 as described above, or in some embodiments, may be located between the photosensitive element 240 and the positioning board 214. Furthermore, the light source 230 may be in contact with the light guide strip 220, or the light source 230 and the light guide strip 220 may have a gap therebetween.

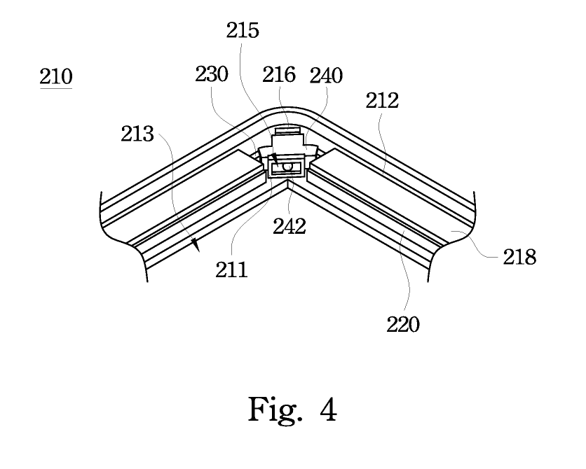

FIG. 4 is a partial perspective view of a front frame 210 of an optical touch display device of another embodiment of the present invention. The front frame 210 includes the body portion 212, the protecting cover 218, a first positioning board 211, and a second positioning board 216. The photosensitive element 240 is fixed between the first positioning board 211 and the second positioning board 216. The second positioning board 216 is located adjacent to a side of the photosensitive element 240 facing away from the lens 242 (i.e., the back side of the photosensitive element 240). The first positioning board 211 is located adjacent to a side of the photosensitive element 240 facing the lens 242 (i.e., the front side of the photosensitive element 240). The first positioning board 211 further includes the transmissive region 215 corresponding to the lens 242. The first positioning board 211 and the second positioning board 216 stand on the body portion 212 and support the photosensitive element 240.

Compared with the conventional front frame 110 (shown in FIG. 1B), the first positioning board 211, the second positioning board 216, and the protecting cover 218 utilized to position the light guide strip 220, the photosensitive element 240, and the light source 230 can be integrated in the front frame 210, such that the thickness of the optical touch display device can be reduced. The following description provides more details in this regard.

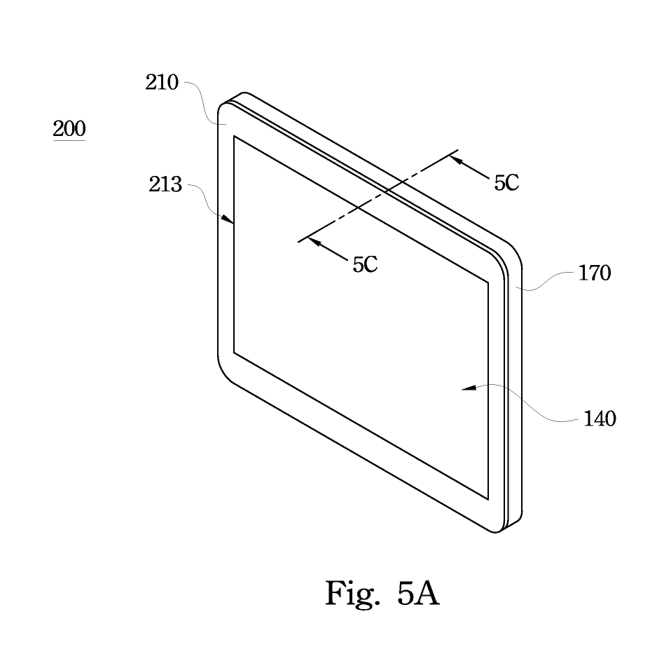

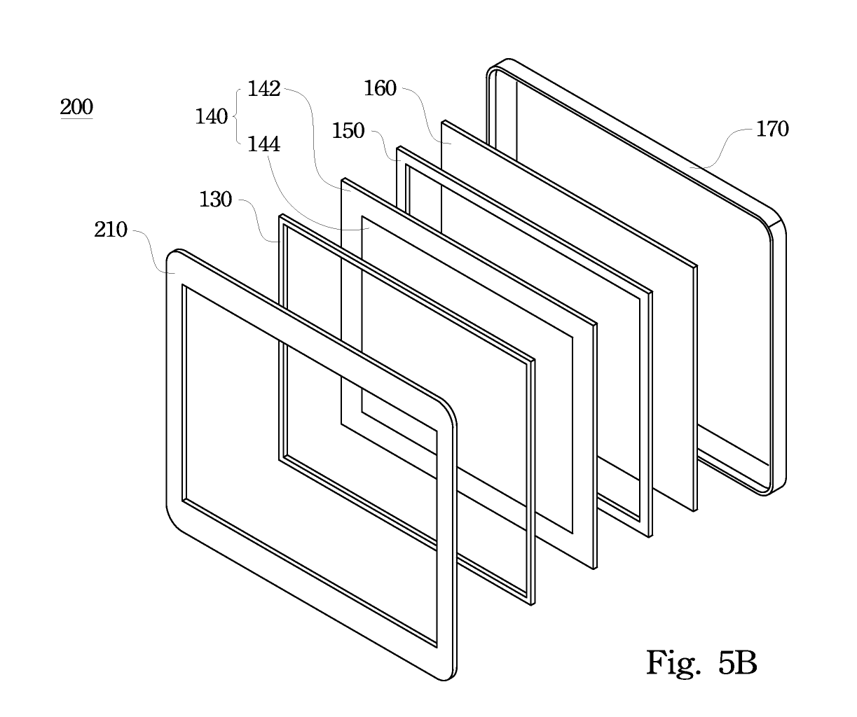

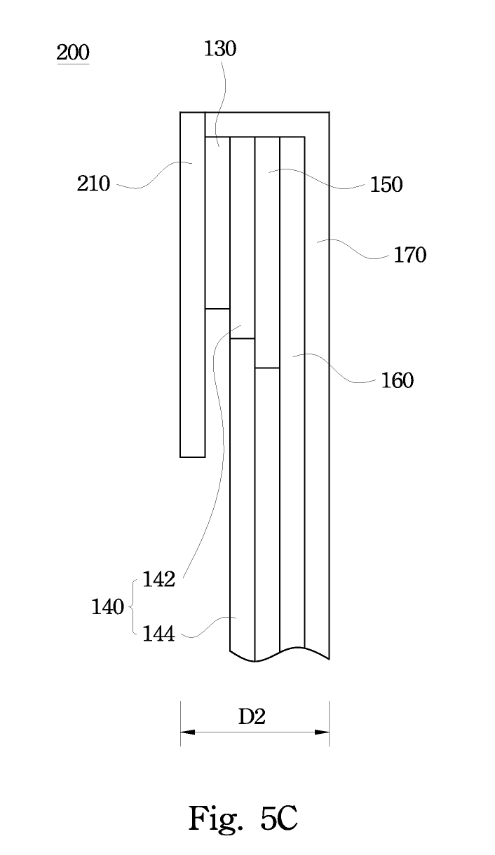

FIG. 5A is a perspective view of an optical touch display device 200 using the front frame 210 shown in FIG. 2. FIG. 5B is an exploded view of the optical touch display device 200 shown in FIG. 5A. As shown in FIG. 5A and FIG. 5B, the optical touch display device 200 includes the front frame 210, the panel front fixing frame 130, the display panel 140, the panel back fixing frame 150, the bottom plate 160, and the back frame 170. The front frame 210 is located on the front side of the optical touch display device 200 and includes the display opening 213. The panel front fixing frame 130 is used to fix the display panel 140 to the front frame 210. The display panel 140 includes the display region 144 and the panel frame 142 surrounding the display region 144. The panel back fixing frame 150 is used to fix the display panel 140 to the bottom plate 160. The back frame 170 is located on the back side of the optical touch display device 200. In this embodiment, the optical touch display device 200 does not include the optical touch module frame 120 shown in FIG. 1B.

FIG. 5C is a cross-sectional view taken along line 5C-5C shown in FIG. 5A. A distance D2 between the front frame 210 and the back frame 170 is defined by the thickness of the front frame 210, the panel front fixing frame 130, the display panel 140, the panel back fixing frame 150, the bottom plate 160, and the back frame 170. Because the optical touch display device 200 does not include the optical touch module frame 120 shown in FIG. 1B, the distance D2 between the front frame 210 and the back frame 170 is smaller than the distance D1 (shown in FIG. 1C).

However, in this embodiment, the optical touch display device 200 still needs the panel front fixing frame 130 to couple to the front frame 210 and the panel frame 142. Therefore, if designers desire to further reduce the distance D2, positioning structures of the display panel 140 can also be integrated in the front frame 210.

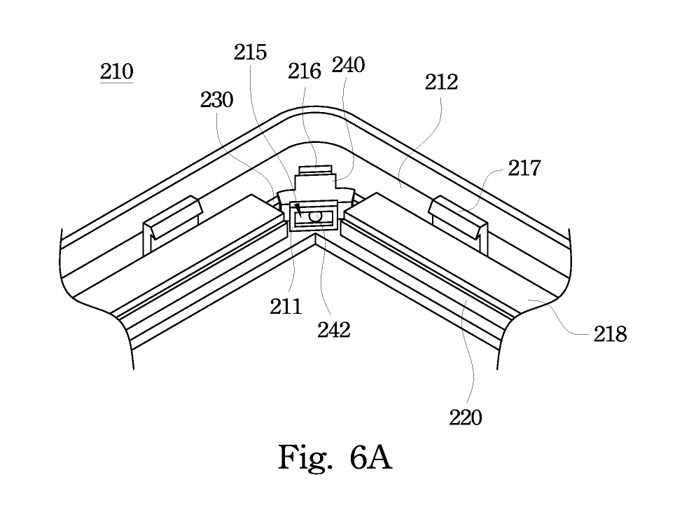

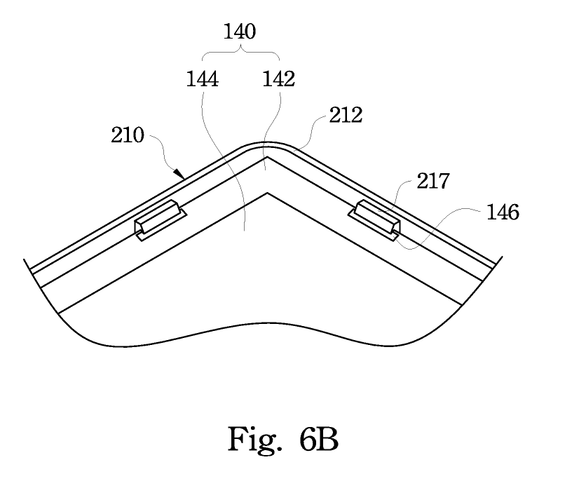

FIG. 6A is a partial perspective view of a front frame 210 of an optical touch display device of another embodiment of the present invention. FIG. 6B is a partial perspective view of a combination of a display panel 140 and the front frame 210 shown in FIG. 6A. As shown in FIG. 6A and FIG. 6B, in this embodiment, the body portion 212 includes the first positioning board 211, the second positioning board 216, the protecting cover 218, and a hook 217. The hook 217 is located on the body portion 212 and coupled to the display panel 140. The hook 217 may be integrally formed on the body portion 212 and may be made of a flexible plastic material.

In this embodiment, the panel frame 142 includes a cavity 146 corresponding to the hook 217 of the front frame 210. Therefore, when the front frame 210 and the display panel 140 are assembled, the hook 217 of the front frame 210 is coupled to the cavity 146 of the panel frame 142, such that the display panel 140 is directly fixed on the front frame 210 without utilizing the panel front fixing frame 130 (shown in FIG. 5B). Accordingly, the thickness of the optical touch display device can be further reduced. The following description provides more details in this regard.

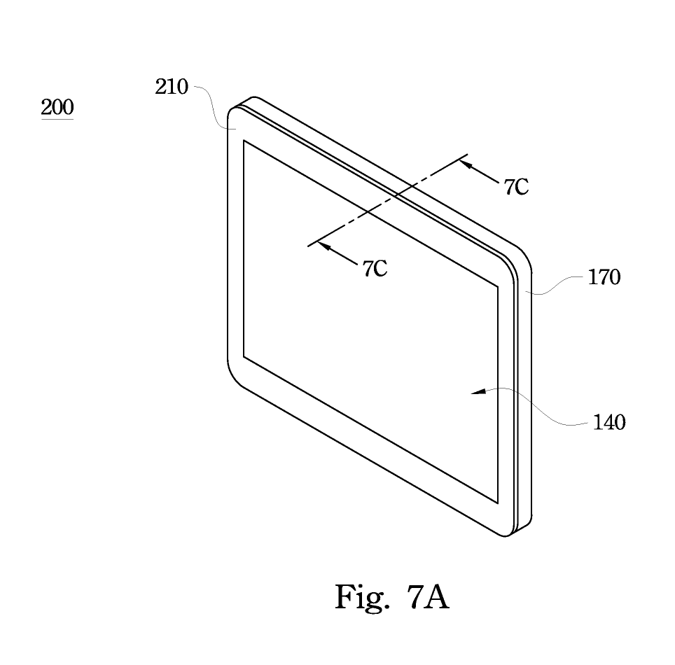

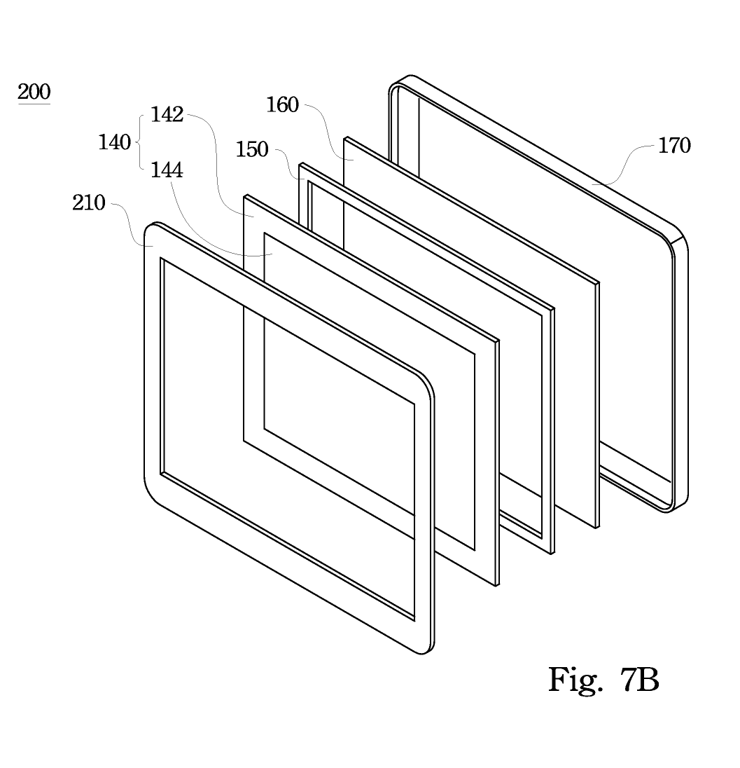

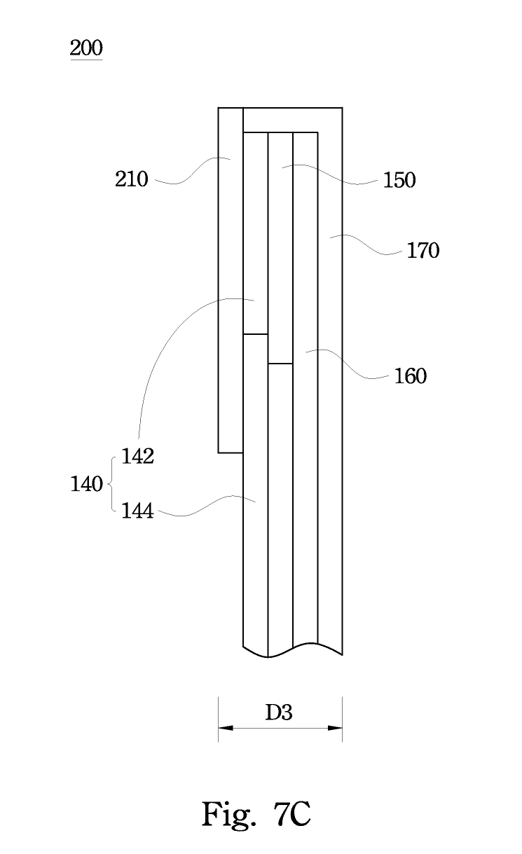

FIG. 7A is a perspective view of an optical touch display device 200 using the front frame 210 shown in FIG. 6A. FIG. 7B is an exploded view of the optical touch display device 200 shown in FIG. 7A. As shown in FIG. 7A and FIG. 7B, the optical touch display device 200 includes the front frame 210, the display panel 140, the panel back fixing frame 150, the bottom plate 160, and the back frame 170. In this embodiment, the optical touch display device 200 does not include the optical touch module frame 120 shown in FIG. 1B, and further does not have the panel front fixing frame 130 (shown in FIG. 5B).

FIG. 7C is a cross-sectional view taken along line 7C-7C shown in FIG. 7A. A distance D3 between the front frame 210 and the back frame 170 is defined by the thickness of the front frame 210, the display panel 140, the panel back fixing frame 150, the bottom plate 160, and the back frame 170. Because the optical touch display device 200 does not include the panel front fixing frame 130 shown in FIG. 5C, the distance D3 between the front frame 210 and the back frame 170 is smaller than the distance D2 (shown in FIG. 5C). Moreover, the distance D3 is significantly smaller than the distance D1 (shown in FIG. 1C).

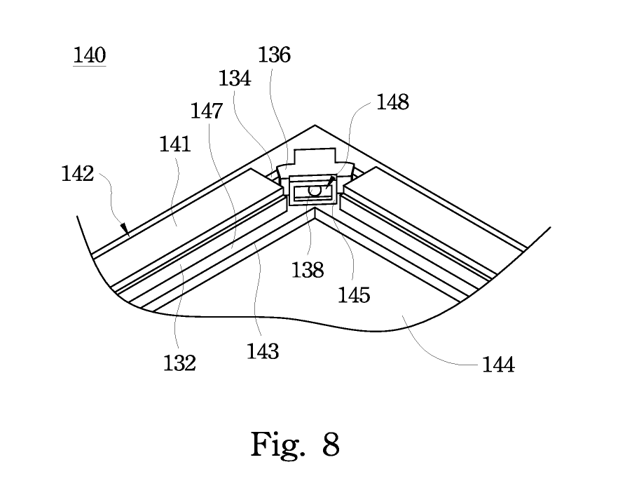

FIG. 8 is a partial perspective view of a display panel 140 of an optical touch display device of another embodiment of the present invention. In this embodiment, the panel frame 142 includes a body portion 143, a positioning board 145, and a protecting cover 141. The positioning board 145 is located on a surface 147 of the body portion 143 facing a display opening and is placed on a corner of the body portion 143. The protecting cover 141 is located on the body portion 143. An end of the protecting cover 141 is adjacent to the positioning board 145. A photosensitive element 136 including a lens 138 is fixed on the positioning board 145. The positioning board 145 includes a transmissive region 148 corresponding to the lens 138. A light source 134 is located between the photosensitive element 136 and a light guide strip 132, and a light-emitting side of the light source 134 faces a light inlet side of the light guide strip 132. In this embodiment, because the photosensitive element 136 and the light guide strip 132 are directly fixed on the panel frame 142, the conventional optical touch module frame 120 (shown in FIG. 1B) is unnecessary. In this way, the objective of reducing the thickness of the optical touch display device still can be achieved.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. An optical touch display device comprising:
a front frame comprising:
a body portion comprising a display opening;
at least one positioning board disposed on a corner of the body portion; and
a protecting cover disposed on the body portion, an end of the protecting cover being adjacent to the positioning board, an opening groove being defined between the protecting cover and the body portion, wherein the body portion, the positioning board, and the protecting cover are integrated;
a light guide strip disposed in the opening groove;
a photosensitive element fixed on the positioning board; and
a light source disposed between the photosensitive element and the light guide strip, wherein a light-emitting side of the light source faces a light inlet side of the light guide strip.

2. The optical touch display device as claimed in claim 1, further comprising:
an adhesive layer for adhering the photosensitive element to the body portion or the positioning board.

3. The optical touch display device as claimed in claim 1, further comprising:
a reflective sheet adhered to an inner wall of the protecting cover facing the light guide strip.

4. The optical touch display device as claimed in claim 1, further comprising a display panel, wherein the body portion further comprises:
a hook disposed on the body portion and coupled to the display panel.

5. The optical touch display device as claimed in claim 1, wherein the protecting cover has an L-shaped profile.

6. The optical touch display device as claimed in claim 1, wherein the photosensitive element comprises a complementary metal oxide semiconductor (CMOS) camera, a charge coupled device (CCD) camera, or a combination thereof.

7. The optical touch display device as claimed in claim 1, wherein the positioning board stands on the body portion and supports the photosensitive element.

8. The optical touch display device as claimed in claim 7, wherein the photosensitive element comprises a lens facing the display opening, and the positioning board is located adjacent to a side of the photosensitive element facing away from the lens.

9. The optical touch display device as claimed in claim 7, wherein the photosensitive element comprises a lens facing the display opening, the positioning board is located adjacent to a side of the photosensitive element facing the lens, and the positioning board further comprises a transmissive region corresponding to the lens.

10. An optical touch display device comprising:
a front frame comprising a display opening;
a display panel disposed in the front frame and comprising a display region and a panel frame surrounding the display region, wherein the panel frame comprises:
a body portion;
at least one positioning board disposed on a surface of the body portion facing the display opening and located on a corner of the body portion; and
a protecting cover disposed on the body portion, an end of the protecting cover being adjacent to the positioning board, an opening groove being defined between the protecting cover and the body portion, wherein the body portion, the positioning board, and the protecting cover are integrated;
a light guide strip disposed in the opening groove;
a photosensitive element fixed on the positioning board; and
a light source disposed between the photosensitive element and the light guide strip, wherein a light-emitting side of the light source faces a light inlet side of the light guide strip.

11. The optical touch display device as claimed in claim 10, further comprising:
an adhesive layer for adhering the photosensitive element to the body portion or the positioning board.

12. The optical touch display device as claimed in claim 10, further comprising:
a reflective sheet adhered to an inner wall of the protecting cover facing the light guide strip.

13. The optical touch display device as claimed in claim 10, wherein the body portion further comprises:
a hook disposed on the body portion and coupled to the front frame.

14. The optical touch display device as claimed in claim 10, wherein the protecting cover has an L-shaped profile.

15. The optical touch display device as claimed in claim 10, wherein the photosensitive element comprises a complementary metal oxide semiconductor (CMOS) camera, a charge coupled device (CCD) camera, or a combination thereof.

16. The optical touch display device as claimed in claim 10, wherein the positioning board stands on the body portion and supports the photosensitive element.

17. The optical touch display device as claimed in claim 16, wherein the photosensitive element comprises a lens facing the display opening, and the positioning board is located adjacent to a side of the photosensitive element facing away from the lens.

18. The optical touch display device as claimed in claim 16, wherein the photosensitive element comprises a lens facing the display opening, the positioning board is located adjacent to a side of the photosensitive element facing the lens, and the positioning board further comprises a transmissive region corresponding to the lens.
